(19) United States
(12) Patent Application Publication
(10) Pub. No.: US 2021/0352920 A1
(43) Pub. Date: Nov. 18, 2021

(54) Process of Meat Packaging

(71) Applicant: Bacon Blend LLC, Bronxville, NY (US)

(72) Inventor: Nathaniel Gallaudet, Bronxville, NY (US)

(21) Appl. No.: 17/245,377

(22) Filed: Apr. 30, 2021

Related U.S. Application Data
(60) Provisional application No. 63/024,938, filed on May 14, 2020.

(51) Int. Cl. A22C 5/00; A23L 13/60; A23L 13/40; B65B 25/06; B65B 25/08; B65D 77/20; A22C 17/00

(52) U.S. Cl. CPC A22C 5/00; A23L 13/67; A23L 13/65; A23L 13/428; A23V 2002/00; B65B 25/08; B65D 77/2024; A22C 17/0026; A22C 17/0093; B65B 25/065

(57) ABSTRACT

A grocery meat product is provided having a tray receiving a raw, fresh, mixed meat product and covered with clear stretch film, the raw mixed meat product having: ten parts by weight raw, fresh beef having a meat-to-fat ratio of 80/20, six parts by weight raw, fresh pork shoulder having a meat-to-fat ratio of 72/38, and four parts by weight raw, fresh applewood-smoked bacon, said beef, said pork shoulder and said applewood-smoked bacon ground mixed together and presented on said tray for sale.

### TECHNICAL FIELD

The present invention relates to grocery meat products and systems and processes for making the same.

### BACKGROUND

Consumers in the United States eat a lot of meat, clocking in at over 200 pounds a year. Despite the form that the meat may take—sausages, patties, or ground, meat is popular and versatile.

Consumers also prefer to save time cooking in the kitchen, and often prefer products that can reduce preparation time.

In recent months, the availability of food has become increasing important, as consumers desire the ability to buy in bulk and buy freezable or frozen food.

Consumers have also grown accustomed to increased options for food products, as new ingredients and foods trends have captured the public's awareness. For instance, many consumers desire additional options for gourmet takes on known staple dishes.

Safety concerns also exist for those looking to sell food products. For instance, any food product sought to be sold must abide by regulations limiting the number of contaminants and preventing the development of pathogens. Specific regulations regarding meats in many cases require periodic testing and conditions for the preparation and packaging of the meat product. In addition, regulations in many cases prohibit the mixing of meat products unless stringent requirements are met.

### SUMMARY

In view of the foregoing problems, it is an object of the present invention to provide a meat product with beef, pork, and bacon and systems and methods for making the meat product that abide by or exceed the safety regulations.

In one aspect of the invention, a grocery meat product is provided having a tray receiving a raw, fresh, mixed meat product and covered with clear stretch film, the raw mixed meat product having: ten parts by weight raw, fresh beef having a meat-to-fat ratio of 80/20, six parts by weight raw, fresh pork shoulder having a meat-to-fat ratio of 72/38, and four parts by weight raw, fresh applewood-smoked bacon, said beef, said pork shoulder and said applewood-smoked bacon ground mixed together and presented on said tray for sale.

In another aspect of the invention, a grocery meat product is provided having a container receiving a raw, frozen, shaped meat product having: ten parts by weight raw, fresh beef having a meat-to-fat ratio of 80/20, six parts by weight raw, fresh pork shoulder having a meat-to-fat ratio of 72/38, and four parts by weight raw, fresh applewood-smoked bacon, said beef, said pork shoulder and said applewood-smoked bacon ground, shaped, and presented on said container for sale.

In another aspect of the invention, a process for producing a meat product is described with the steps of providing beef, pork, and bacon, storing each of the beef, pork, and bacon in cold storage at a temperature between 32 F and 41 F, and grinding the beef, pork, and bacon in a blender at a temperature between 32 F and 41 F.

In another aspect of the invention, the process further includes the steps of forming the beef, pork, and bacon into patties at a temperature between 32 F and 41 F, separating the patties by wax paper at a temperature between 32 F and 41 F, packaging the patties in a plastic bag inside a cardboard box at a temperature between 32 F and 41 F, and shipping the patties at a temperature at or below 32 F.

### BRIEF DESCRIPTION OF THE DRAWINGS

FIG. 1 is a schematic of a system and process of the present invention.

### DETAILED DESCRIPTION

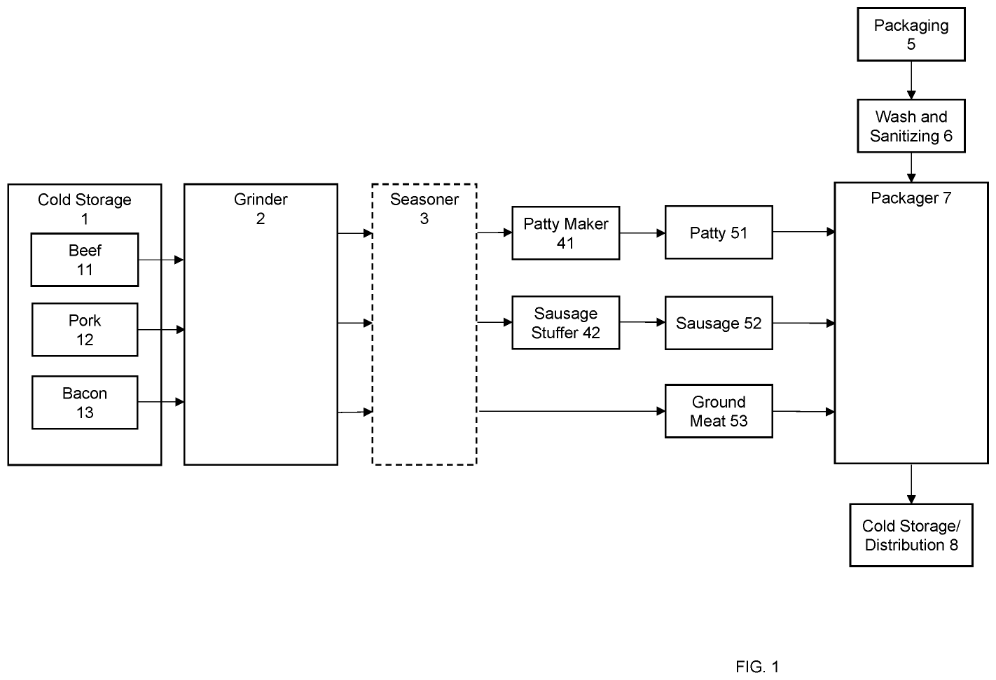

As shown in FIG. 1, the system and process of the claimed invention may include a cold storage 1. The cold storage 1 may be a commercial refrigeration unit. The cold storage 1 may be kept at a temperature between 32 F and 41 F to prevent microbiological growth.

Beef 11 may be received and placed in the cold storage 1. The beef 11 may preferably be chuck, round, brisket, navel, short rib, or a combination thereof. Beef 11 is preferably raw and fresh. The beef 11 preferably has a meat-to-fat ratio of 80/20.

Pork 12 may be received and placed in the cold storage 1. Pork 12 is preferably raw and fresh. The pork 12 may preferably be pork shoulder, pork butt, or a combination thereof. The pork 12 preferably has a meat-to-fat ratio of 72/38.

Bacon 13 may be received in placed in the cold storage 1. Bacon 13 is preferably raw and fresh. The bacon 13 may preferably be applewood-smoked bacon.

The beef 11, pork 12, and bacon 13 may be removed from the cold storage 1 for grinding in the grinder 2. The beef 11, pork 12, and bacon 13 should be kept at a temperature between 32 F-41 F during the grinding process to prevent microbial growth. The beef 11, pork 12, and bacon 13 may be ground and mixed together in a ratio of ten parts by weight of beef 11, six parts be weight of pork 12, and four parts by weight of bacon 13. Alternatively, a ratio of ten parts by weight of beef 11, three parts be weight of pork 12, and two parts by weight of bacon 13 may be used.

After grinding, the beef 11, pork 12, and bacon 13 combination may optionally be seasoned using a seasoner 3. For example, if the meat product is to be a patty, it may be seasoned with salt and pepper. If the meat product is to be a sausage, seasonings such as parsley, pepper, fennel, paprika, red pepper flakes, salt, onion and garlic may be used. If vegetables are used to seasons, they should be washed in a vegetable sanitizer or blanched at temperatures >180 F to kill any pathogens. Seasonings should be stored to prevent contamination, and added such that they will not raise the temperature of the beef 11, pork 12, and bacon 13 combination above 41 F.

The beef 11, pork 12, and bacon 13 combination may then be provided to a patty maker 41, or a sausage stuffer 42, for forming into patties or sausages. The beef 11, pork 12, and bacon 13 should be kept at a temperature between 32 F-41 F during the patty forming or sausage stuffing processes to prevent microbial growth. The patties and sausages formed may include approximately 6 oz of the mixture. Alternatively, the combination may be kept as a ground meat product.

Packaging 5 may then be retrieved. The packaging 5 must be a washed and sanitized 6 before coming into contact with any meat product. Packaging 5 may include a tray, clear stretch film, a container, plastic bags, and other products.

The packager 7 may preform differently depending on the type of meat product received. The meat product, however, should be kept at a temperature between 32 F-41 F to prevent microbial growth during the packaging process.

The packager 7 for ground meat 53 may include providing a tray for receiving the ground meat 53. After the ground meat is placed on the tray, the tray may be covered with clear stretch film.

The packager 7 for patties 51 may include placing a sheet of wax paper between each patty. Patties 51 may be stacked in groups, preferably of six. The stack of patties 51 may be placed into a plastic bag, which is then closed. The stack of patties 51 may also be placed into a cardboard box. Alternatively, patties 51 may be separated by a sheet of wax paper in groups and placed on a tray to be covered with clear stretch film.

The packager 7 for sausages 52 may include placing the sausages 52 into a plastic bag, which is then closed. The sausages 52 may also be placed into a cardboard box. Alternatively, sausages 51 may be grouped and placed on a tray to be covered with clear stretch film.

The packaged meat products, whether patties 51, sausages 52, or ground meat 53, may be kept in cold storage 8 prior to distribution 8. Cold storage and distribution 8 may be keep the meat products between 32 F and 41 F. Alternatively, cold storage and distribution 8 may keep the meat products below 32 F. Once distributed to grocery stores and the like, the meat products may be presented for sale.

For any of the above steps, the ambient temperature or the temperature of the meat product may be recorded.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A grocery meat product comprising:
a tray receiving a raw, fresh, mixed meat product and covered with clear stretch film, the raw mixed meat product having:
ten parts by weight raw, fresh beef having a meat-to-fat ratio of 80/20,
six parts by weight raw, fresh pork shoulder having a meat-to-fat ratio of 72/38, and
four parts by weight raw, fresh applewood-smoked bacon;
said beef, said pork shoulder and said applewood-smoked bacon ground mixed together and presented on said tray for sale.

2. The grocery meat product of claim 1, wherein said beef, said pork shoulder and said applewood-smoked bacon ground are kept at a temperature below 41 F.

3. The grocery meat product of claim 2, wherein said beef, said pork shoulder and said applewood-smoked bacon ground are kept at a temperature below 32 F.

4. A grocery meat product comprising:
a container receiving a raw, frozen, shaped meat product having:
ten parts by weight raw, fresh beef having a meat-to-fat ratio of 80/20,
six parts by weight raw, fresh pork shoulder having a meat-to-fat ratio of 72/38, and
four parts by weight raw, fresh applewood-smoked bacon;
said beef, said pork shoulder and said applewood-smoked bacon ground, shaped, and presented on said container for sale.

5. The grocery meat product of claim 4, wherein said beef, said pork shoulder and said applewood-smoked bacon ground are kept at a temperature below 41 F.

6. The grocery meat product of claim 4, wherein said beef, said pork shoulder and said applewood-smoked bacon ground are kept at a temperature below 32 F.

7. The grocery meat product of claim 4, wherein said beef, said pork shoulder and said applewood-smoked bacon ground are shaped into patties.

8. The grocery meat product of claim 7, wherein said patties are separated by wax paper.

9. The grocery meat product of claim 4, wherein said beef, said pork shoulder and said applewood-smoked bacon ground are shaped into sausages.

10. A process for producing a meat product, comprising:
providing beef, pork, and bacon;
storing each of the beef, pork, and bacon in cold storage at a temperature between 32 F and 41 F;
grinding the beef, pork, and bacon in a blender at a temperature between 32 F and 41 F.

11. The process of claim 10, further comprising:
forming the beef, pork, and bacon into patties at a temperature between 32 F and 41 F;
separating the patties by wax paper at a temperature between 32 F and 41 F; and
packaging the patties in a plastic bag inside a cardboard box at a temperature between 32 F and 41 F;
shipping the patties at a temperature at or below 32 F.

12. The process of claim 10, further comprising:
forming the beef, pork, and bacon into sausages at a temperature between 32 F and 41 F;
packaging the sausages in a plastic bag inside a cardboard box at a temperature between 32 F and 41 F;
shipping the sausages at a temperature at or below 32 F.

13. The process of claim 1, further comprising:
packaging the ground meat is packaged in a plastic bag inside a cardboard box at a temperature between 32 F and 41 F;
shipping the ground meat at a temperature at or below 32 F.

14. The process of claim 1, further comprising recording the temperature during at least one step.

15. The process of claim 1, wherein the bacon is applewood-smoked.

16. The process of claim 1, wherein the beef has a meat-to-fat ratio of 80/20.

17. The process of claim 1, wherein the pork has a meat-to-fat ratio of 72/38.

18. The process of claim 1, wherein the beef, pork and bacon are provided at a ratio of 10:6:4.

19. The process of claim 1, wherein the beef, pork and bacon are provided at a ratio of 10:3:2.

20. The process of claim 1, further comprising the step of seasoning the beef, pork, and/or bacon.
